(19) United States
(12) Patent Application Publication
(10) Pub. No.: US 2023/0240268 A1
(43) Pub. Date: Aug. 3, 2023

(54) SUBSTANCE DELIVERY TO ANIMALS

(71) Applicant: TG Medwise Ltd., Kefar Malal (IL)

(72) Inventors: Tal Gordon, S, AZ (US); Mazal Dahan, Mazkeret Batya (IL)

(73) Assignee: TG Medwise Ltd., Kefar Malal (IL)

(21) Appl. No.: 17/999,923

(22) PCT Filed: May 27, 2021
(86) PCT No.: PCT/IB2021/054653

§ 371 Date: Nov. 27, 2022

Related U.S. Application Data
(60) Provisional application No. 63/030,371, filed on May 27, 2020.
(60) Provisional application No. 63/030,398, filed on May 27, 2020.

(51) Int. Cl. A01K 27/00; A01K 29/00

(52) U.S. Cl. CPC A01K 27/007; A01K 29/005

(57) ABSTRACT

A method of delivering a substance to an animal includes using a controller to topically deliver an initial dosage amount of a substance to a skin of an animal, followed by one or more subsequent dosages of the substance to the skin of the animal. The initial dosage amount comprises a plurality of sub-initial doses delivered at discrete time intervals separated from one another by time gaps with no dosage delivered during the gaps and a total amount of the sub-initial doses equals the initial dosage amount.

### FIELD OF THE INVENTION

The present invention relates generally to methods of delivery of substances to animals, such as but not limited to, drugs and pharmaceuticals, and particularly to methods and protocols of substance delivery to the coat, fur or skin of animals.

### BACKGROUND OF THE INVENTION

Drug delivery devices for delivering substances to pets are described in PCT Patent Application WO 2014/028427. The delivery device has an actuating chamber with an actuating substance, sealed by a chamber membrane.

### SUMMARY OF THE INVENTION

The present invention seeks to provide an improved controlled drug delivery device which may or may not be wearable, such as on an animal, as is described more in detail hereinbelow. The delivery device is for delivering substances, such as but not limited to, drugs, pharmaceuticals, pheromones, scents and deodorizers. The terms “substance” and “drug” are used interchangeably throughout and it is noted that these terms encompass more than just a drug, pharmaceutical, pheromones, scent or deodorizer, but also any chemical used to effect a desired result. The delivery device of the invention may be of any size and shape.

Some of the substances which can be delivered by the delivery device include, without limitation, anti-flea compounds, anti-tick compounds, anti-parasite compounds, anti-fungal compounds, anti-bacterial compounds, anti-viral compounds, calming drugs, analgesic drugs and other pain drugs, and others, in the form of liquids, gels, ointments and any other flowable substances, referred to herein as fluids. The substance can be for topical/external use/treatment, spot-on use/treatment, or for systemic use/treatment, or for both external and systemic treatments. For example, a formulation may include topical chemical actives such as, but not limited to, Fipronil, Permethrin, Imidacloprid, or others, for treating (e.g., killing and/or repelling) external ecto-parasites such as fleas, ticks, mosquitoes, flies, and others. The substance may include transdermal systemic actives such as, but not limited to, Moxidectin, Selamectin, and others, which enter the body through the skin for treating endo-parasites such as heartworm, hookworm, roundworm, and others.

The delivery device of the invention includes a controller for controlling the drug delivery according to different protocols, as is described more in detail hereinbelow.

There is thus provided in accordance with a non-limiting embodiment of the invention a method of delivering a substance to an animal including using a controller to topically deliver an initial dosage amount of a substance to a skin (or fur/hair) of an animal, followed by one or more subsequent dosages of the substance to the skin of the animal, wherein the initial dosage amount may include a plurality of sub-initial doses delivered at discrete time intervals separated from one another by time gaps with no dosage delivered during the gaps and a total amount of the sub-initial doses equals the initial dosage amount.

In accordance with a non-limiting embodiment of the invention the substance is a pest control substance and the initial dosage amount results in a concentration of active/s on the skin (or fur/coat) exceeding a first active/s concentration threshold level necessary for achieving efficacy level for killing pests that have infested the animal before the administration of the initial dosage amount, and the one or more subsequent dosages are sufficient for maintaining a concentration of active/s on the skin (or fur/coat) exceeding a second active/s concentration threshold level, which may or may not be less than the first threshold level, necessary for maintaining efficacy level for killing or preventing or deterring/repelling re-infestation of the animal during the treatment period.

In accordance with a non-limiting embodiment of the invention the one or more subsequent dosages are smaller than the initial dosage amount.

In accordance with a non-limiting embodiment of the invention the initial dosage amount is zero.

In accordance with a non-limiting embodiment of the invention the method includes using the controller to modify dosages of the substance.

In accordance with a non-limiting embodiment of the invention dosages of the substance are modified by taking into account an environmental factor.

In accordance with a non-limiting embodiment of the invention dosages of the substance are modified by taking into account a climate change, a temperature change or a humidity change.

In accordance with a non-limiting embodiment of the invention dosages of the substance are modified by taking into account an immunity level of the pests/parasites.

In accordance with a non-limiting embodiment of the invention dosages of the substance are modified by taking into account presence of an allergen, an irritant or a pest.

In accordance with a non-limiting embodiment of the invention the method includes using the controller to modify a time interval between dosages of the substance.

In accordance with a non-limiting embodiment of the invention the method includes using the controller to modify a time duration of dosage of the substance.

In accordance with a non-limiting embodiment of the invention the method includes using the controller to modify an amount of dosage of the substance.

In accordance with a non-limiting embodiment of the invention the method includes using the controller to select between different dosing protocols, wherein the initial dosage amounts of the dosing protocols are selected from zero to an amount larger than zero, and the one or more subsequent dosages are selected from zero to an amount larger than zero.

In accordance with a non-limiting embodiment of the invention selection of one of the dosing protocols is done by a veterinarian or an owner of the animal.

In accordance with a non-limiting embodiment of the invention selection of one of the dosing protocols is done through an application using a communication link (without limitation, smartphone, personal communication device, computer, and many more).

In accordance with a non-limiting embodiment of the invention selection of one of the dosing protocols or setting specific dosing parameters is done taking into account at least one of the following parameters: a data base, a specific animal breed, animal weight, hair length, time spent by the animal indoors or outdoors, usage history, seasonality, time of year, geography, immunity level of the pests/parasites, adverse or allergic reactions to the substance, climate, temperature, humidity, anxiety factors, and behavioral data.

In accordance with a non-limiting embodiment of the invention the method includes using the controller to synergistically combine topical dosage of the substance in cooperation with a well-being device. The well-being device may be a separate device or may be well-being functionalities integrated into the device. Data collection, analysis and calculations of dosing instructions may be done, without limitation, by using cloud servers, big data and communication links.

In accordance with a non-limiting embodiment of the invention the substance includes a combination of different substances.

In accordance with a non-limiting embodiment of the invention topical delivery of the substance further causes a systemic change in the animal.

There is provided in accordance with a non-limiting embodiment of the invention a method of delivering a substance to an animal including using a controller to deliver a substance to a skin or fur/hair of an animal, sensing a parameter associated with the substance or the animal, and using feedback from the sensor to control further delivery of the substance to the skin of the animal.

The present invention seeks to provide an improved controlled drug delivery device which combines pet drug delivery with pet well-being, as is described more in detail hereinbelow. The delivery device is for delivering substances, such as but not limited to, drugs, pharmaceuticals, scents, pheromones, and deodorizers. The terms “substance” and “drug” are used interchangeably throughout and it is noted that these terms encompass more than just a drug, pharmaceutical, scent or deodorizer, but also any chemical used to effect a desired result. The delivery device of the invention may be of any size and shape.

Some of the substances which can be delivered by the delivery device include, without limitation, anti-flea compound, anti-tick compounds, anti-parasite compounds, anti-fungal compounds, anti-bacterial compounds, anti-viral compounds, calming drugs, analgesic drugs and other pain drugs, pest or parasitic deterrents/repellents or control substances, and others, in the form of liquids, gels, ointments and any other flowable substances, referred to herein as fluids. The invention is applicable for any animal, such as but not limited to, dogs, cats, farm animals, such as horse, cattle, sheep, goats, etc., or other pets or animals. Alternatively, some embodiments may be applicable for humans.

There is provided in accordance with a non-limiting embodiment of the invention a method of animal care including using a well-being controller to make a comparison of a well-being parameter of an animal with a known value of the well-being parameter, and using a delivery controller to control drug delivery to the animal, wherein the delivery controller includes the well-being controller or is different from the well-being controller.

The method may use the well-being controller or the delivery controller to control drug delivery to the animal as a function of the comparison. The known value of the well-being parameter may be a parameter in a range defined in a well-being protocol as a normal range, or may be a previously measured parameter, or may be derived from learning or studying previous behavior or previous well-being parameters of the animal, or may be a previously stored parameter.

The well-being controller or the delivery controller may provide information to a user and/or a veterinarian about the drug delivery or the well-being of the animal. The well-being controller or the delivery controller may receive information about the drug delivery and the well-being of the animal and may modify a parameter of the drug delivery or of the well-being of the animal in response to the information. The drug delivery may include topical drug delivery to a skin, fur or coat of the animal and the well-being may be topical or systemic well-being of the animal. The drug delivery may include timed sequences of doses, at least one bolus, or a combination thereof. The drug delivery may include delivery of different drugs or two or more separate drugs dosed independently. The drug delivery may include delivering the drug via an article worn by the animal, such as a collar, harness, bracelet or other means.

The well-being controller or the delivery controller may receive the information from a drug delivery sensor and from a well-being sensor. The well-being sensor may include a motion sensor that senses a motion of the animal. The well-being sensor may include a plurality of motion sensors, each of the motion sensors sensing a motion of a different portion of the animal and the well-being controller or the delivery controller may interpret the motions as parameters of the well-being of the animal. The well-being sensor may include a temperature sensor that senses a temperature of the animal or ambient temperature, or a pulse sensor that senses a pulse of the animal, or a chemical sensor that senses at least one of a breath, a perspiration, an exudate, a tear, a hormonal secretion and a saliva of the animal, or an optical sensor, or an accelerometer.

The well-being controller or the delivery controller may modify delivery of the drug by taking into account an environmental factor, a climate change, an ambient temperature change or a humidity change, or an immunity level of the parasites, or presence of an allergen, an irritant or a pest.

The well-being controller or the delivery controller may modify a time interval between dosages of the drug, or a time duration of dosage of the drug, or an amount of dosage of the drug.

The well-being controller or the delivery controller may be used to select between different dosing protocols, wherein the initial bolus amounts of the dosing protocols are selected from zero to an amount larger than zero, and the one or more subsequent dosages are selected from zero to an amount larger than zero. The selection may be done by a veterinarian or an owner of the animal, or through an application using a communication link. The selection of one of the dosing protocols may be done taking into account at least one of the following parameters: a data base, a specific animal breed, animal weight, hair length, time spent by the animal indoors or outdoors, usage history, seasonality, time of year, geography, immunity level of the parasites, adverse or allergic reactions to the substance, climate, temperature, humidity, anxiety factors, and behavioral data.

There is provided in accordance with a non-limiting embodiment of the invention animal care apparatus including a well-being controller configured to make a comparison of a well-being parameter of an animal with a known value of the well-being parameter, and a delivery controller configured to control drug delivery to the animal, wherein the delivery controller includes the well-being controller or is different from the well-being controller. A computer-implemented method for animal care may include providing an app to an interface device, such as a smartphone or other device, having a computer processor and memory storing computer code, the app being associated with a well-being parameter of an animal or drug delivery to the animal. Animal care apparatus may include an interface device having a computer processor and memory storing computer code to execute an app associated with a well-being parameter of an animal or drug delivery to the animal.

### BRIEF DESCRIPTION OF THE DRAWINGS

The present invention will be understood and appreciated more fully from the following detailed description taken in conjunction with the drawings in which:

FIGS. 1A and 1B are simplified graphical illustrations of initial dose and resultant concentration of active/s on skin of the animal, respectively, in accordance with a non-limiting embodiment of the present invention;

FIGS. 2A and 2B are simplified graphical illustrations of ongoing micro-dosing and resultant concentration of active/s on skin of the animal, respectively, in accordance with a non-limiting embodiment of the present invention;

FIGS. 3A and 3B are simplified graphical illustrations of a treatment (that includes initial dose and ongoing micro-dosing) and resultant concentration of active/s on skin of the animal, respectively, in accordance with a non-limiting embodiment of the present invention;

FIGS. 3C and 3D are simplified graphical illustrations of a treatment (that includes initial dose and ongoing micro-dosing) and resultant concentration of active/s on skin of the animal, respectively, in accordance with another non-limiting embodiment of the present invention;

FIG. 4 is a simplified graphical illustration of micro-doses of a substance, such as but not limited to, 20 micro-doses of 13.4 μl at one-minute intervals, in accordance with a non-limiting embodiment of the present invention;

FIG. 5 is a simplified block diagram of a system and method of delivery of substances and well-being for animals, constructed and operative in accordance with a non-limiting embodiment of the present invention;

FIGS. 6A and 6B are simplified illustrations of a device for delivery of substances and well-being for animals, constructed and operative in accordance with a non-limiting embodiment of the present invention; and

FIG. 6C is a simplified block diagram of the components of the device of FIGS. 6A and 6B.

### DETAILED DESCRIPTION OF EMBODIMENTS

Accordingly, the invention provides dosage control for the duration of the treatment. The substance is delivered to the skin/coat/fur of the animal (the term “skin” is used throughout to encompass skin, coat, fur, etc.). Without limitation, the substance or at least the active ingredient of the substance, may spread, such as by diffusion, over the skin or other parts of the body.

One of the problems in administering topical substances to the skin of the animal as opposed to other modes of delivery, such as injections or ingestion, is that the topical substance must disperse or otherwise spread out over the skin. If the substance does not disperse properly, a pool of the substance may accumulate at one spot or zone on the skin. This creates a localized concentration of the substance which has many drawbacks. First, it can create a localized overdose of the substance, which may be harmful (for example, skin irritation or burns). Second, localized concentration of the substance cannot properly be delivered at the requisite rate, thereby seriously diminishing its efficacy. Third, greasy spots may be formed, which could cause some of the substance to pass and contaminate a person petting the animal or the surroundings of the animal. Fourth, the localized concentration of the substance may result in a spillover of the substance onto the surroundings, such as backflow onto the collar and the device (which are described further below) or onto people petting the animal, etc., resulting in insufficient amount of substance dispensed and dispersed onto animal skin.

There are many situations, such as an animal already infested with pests prior to starting treatment, wherein it is required to deliver a higher initial dose of the substance at a beginning of treatment to deal with the initial infestation. Treating or killing pre-treatment infestation is more challenging as the parasites (fleas, ticks, etc.) are fattened and have gained strength and the population is well infested on the animal. Topical delivery of a one-time bolus may create the above-described pooling effect with all its disadvantages. The invention provides a solution to this challenge.

The initial dose (e.g., bolus) may not be a single one-time large dose. Instead it may be a sequenced set of discrete doses which avoids the pooling problem and enables improved or optimal spreading of the topical substance on the animal's skin. It is noted that the topical formulation may be a systemic formulation that enters the animal's body through the skin (for treating internal parasites, or other systemic treatment such as pain relief and others.) Alternatively, the initial dose may be single one-time large dose, or still alternatively, may be administered continuously over a defined time lasting seconds, minutes, hours or days, or as a series of continuous small doses or pulses of doses.

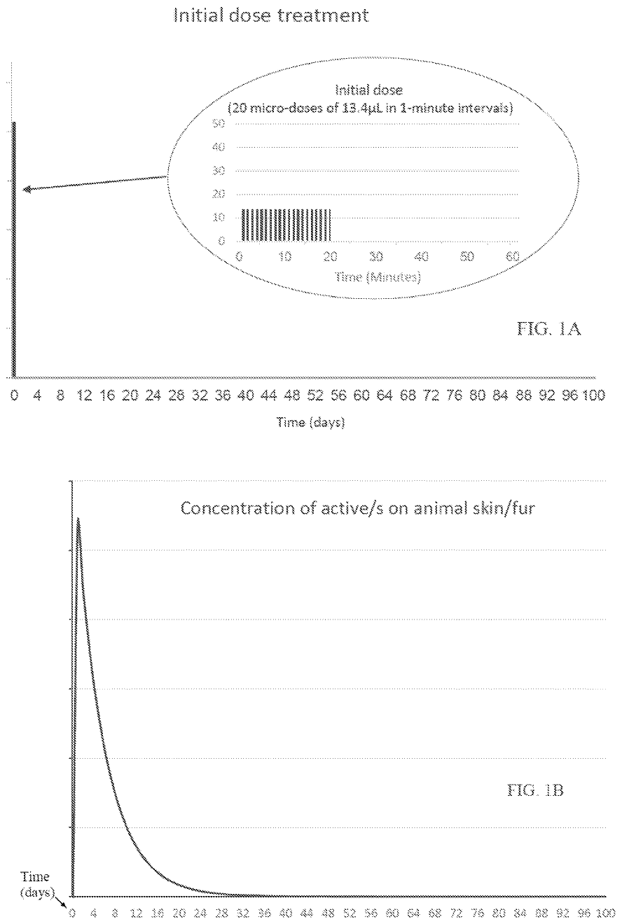

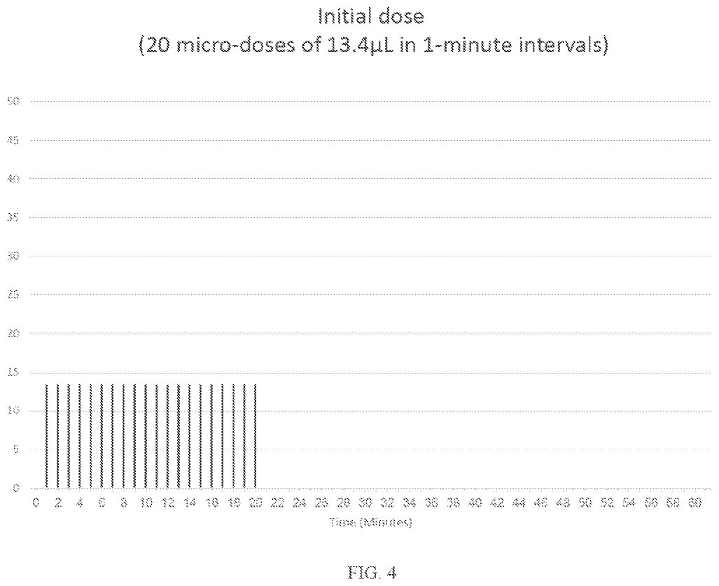

Non-limiting examples of substance delivery protocols are shown in FIGS. 1A, 1B, 2A, 2B, 3A and 3B. An example of an initial dose is shown in FIG. 4.

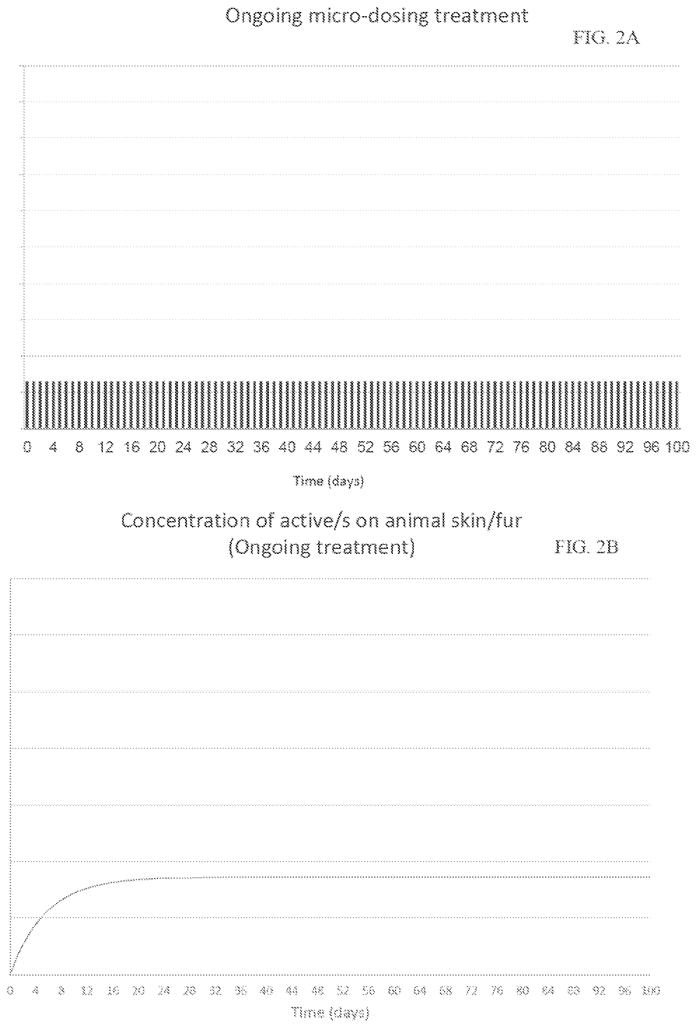

In the illustrated examples, there may be an initial, relatively large dose (FIGS. 1A and 1B), or lower ongoing amounts of the substance during an ongoing treatment (FIGS. 2A and 2B).

For example, in FIG. 1A, instead of one single large bolus, an initial dose is delivered that is made of 20 micro-doses of 13.4 μl in one-minute intervals over 20 minutes. As seen in FIG. 1B, this results in a concentration of active or actives on the skin of the animal, in which the concentration is very high at the beginning and asymptotically diminishes rapidly over time.

The protocol of FIGS. 1A and 1B may not be effective in the long term, but it is intended to be effective to treat pre-treatment infestations.

In contrast to the example of FIGS. 1A and 1B, in the example of FIGS. 2A and 2B, an on-going treatment plan is presented. In this non-limiting example, 1.34 ml of anti-flea and tick topical/spot-on formulation containing Fipronil and s-Methoprene (commonly used for manual administration/treatment on medium size dogs for a one month anti-flea and tick treatment), is administrated in small doses over an extended treatment period.

In one example of the invention, a daily dose of 13.4 μl (1% of the recommended manual monthly dose) is automatically dosed every day by the device. The resultant concentration of Fipronil on skin of the animal for this treatment is shown in FIG. 2B. As seen, within ˜20 days the concentration converges to a steady state concentration level and is maintained at this level for as long as the daily micro-dosing treatment continues. Such a protocol is effective in the long term, but may fail to treat pre-treatment infestations.

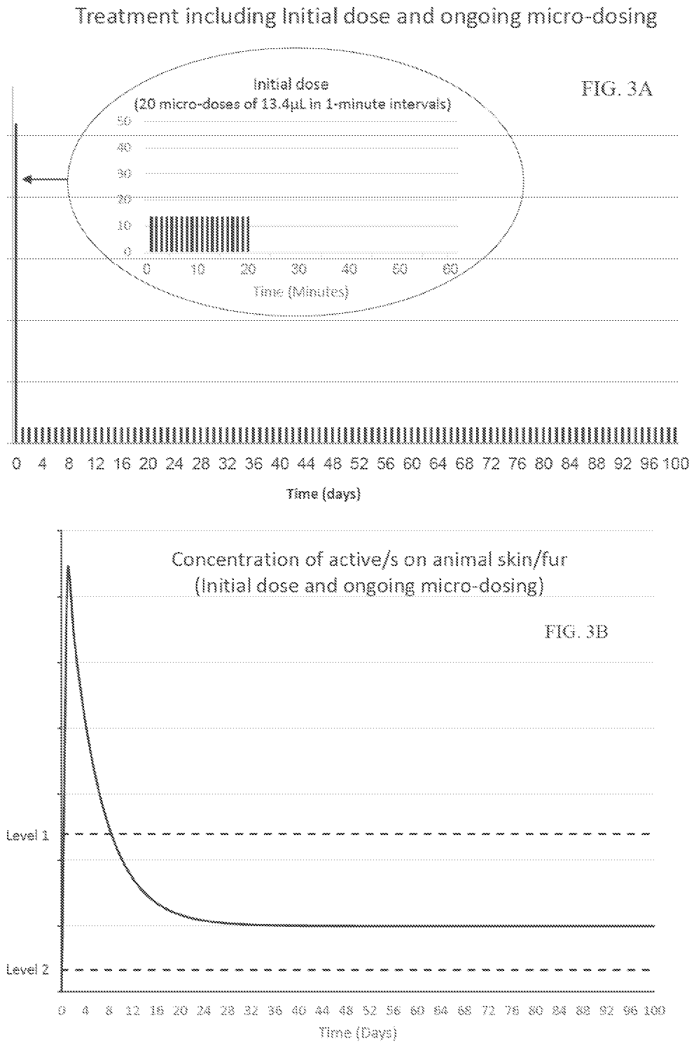

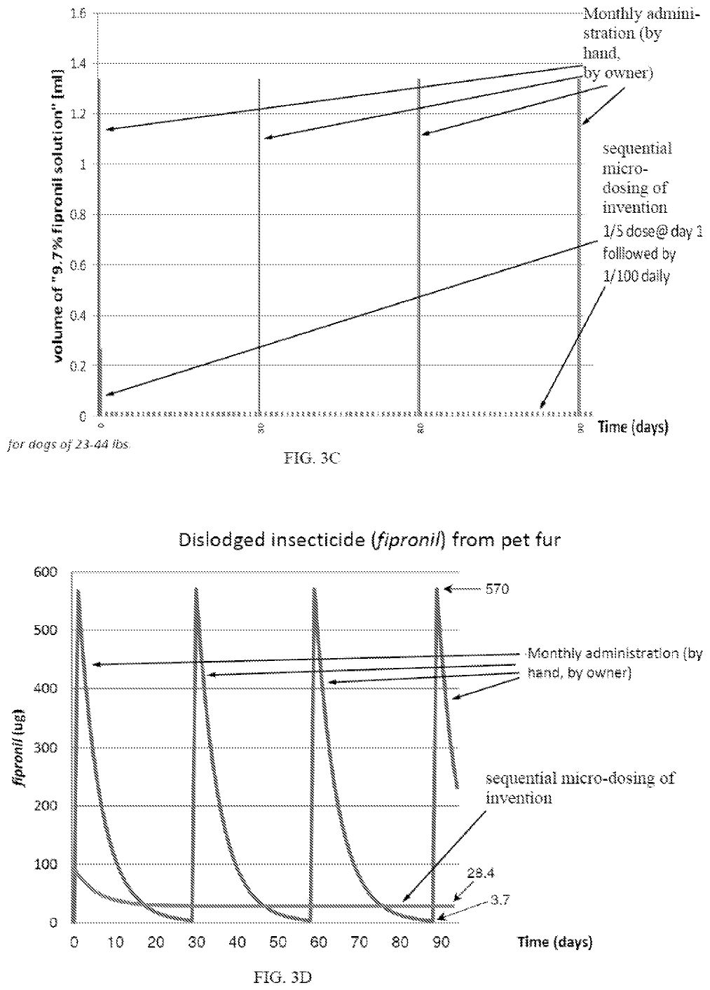

FIG. 3A shows another treatment that includes an initial dose and ongoing micro-dosing; FIG. 3B shows the resultant concentration on skin of the animal for this treatment.

For example, if the discrete dosage volume=1% of the total amount of the recommended monthly dose (usually administrated manually once a month)=13.4 μl, then instead of an initial dose of 20%, one can deliver 20 dosages of 1% with very little time between them, such as one-minute intervals, as shown in FIG. 4. This is the equivalent of a single initial dose of 20×13.4 μl=268 μl. Subsequently, as shown in FIGS. 2A and 3A, on-going daily doses of, 13.4 μl, may be administered for the duration of the treatment (e.g., 10 days, 30 days, 100 days, full year, or other durations). The initial dose split to 20 dosages avoids the pooling problem, yet have a high efficacy to treat the initial infestation.

The amount of substance in the initial dose is defined to achieve a higher concentration of active/s on animal's skin above a first concentration threshold level (Level-1, as seen in FIG. 3B), which is the concentration level required for achieving the initial kill of pre-treatment infestation, that is, for achieving efficacy against pre-treatment infestation. (Without limitation, the initial kill may be achieved within 4, 12, 24, 48, 72, or 96 hours, depending on the amount of formulation administrated in the initial dose). However, in accordance with an embodiment of the invention, the initial dose is still much smaller, such as but not limited to, only ˜20% of the manual monthly recommended dose; the initial dose only treats the pre-treatment infestation, so that it kills or eliminates only pests already existing on the animal. In other words, the initial dose is not intended to kill or repel later infestations during the treatment, but rather only at the beginning of the treatment.

The amount of substance in the ongoing treatment is defined to achieve a concentration of active/s on animal's skin above a second concentration threshold level (Level-2, as seen in FIG. 3B), which is the concentration level required for achieving kill or repel of later infestations already during the treatment, that is, for achieving efficacy against on-going infestation. The second efficacy level for ongoing kill or repel is usually significantly lower than the first efficacy level for killing pre-treatment infestation.

It is noted that the substance is delivered at a certain dose which contains a certain level of active or actives (for simplicity, referred to as active in the singular). This level of active provides a level of efficacy for treating (preventing, killing, repelling, and the like) pests. Thus, a first amount of active provides a first level of efficacy and a second amount of active provides a second level of efficacy.

FIG. 3C shows of an automatic micro-dosing treatment protocol that includes an initial dose and ongoing micro-dosing, compared to a monthly manual administration spot-on treatment; FIG. 3D shows the comparison of the resultant concentration on skin of the animal for the two treatments. In FIG. 3C, a micro-dosing protocol includes a ⅕ sub-dose (compared to the manual monthly dose) on the first day followed by 1/100 daily sub-doses. The sub-doses are Fipronil plus s-Methoprene formulation and are compared with a commercial once monthly manual administration. FIG. 3D compares the amount of insecticide on the pet skin/fur by administration in accordance with an aspect of the invention as opposed to manual spot-on administration. The efficacy of the invention is clearly superior to the manual administration, while the exposure to toxic substance is significantly lower, thus much safer.

Accordingly, the protocols of the invention first achieve the initial kill or repel (e.g., without limitation, using only about 20% of the recommended one-monthly manual dose), and then continue with an ongoing treatment with an average daily dose of, without limitation, only 1% (or even lower) sufficient for kill or repel of new infestations during the treatment. The treatment can continue indefinitely (with no degradation) for as long as the ongoing micro-dosing treatment continues.

Accordingly, the invention dramatically reduces the amount of drug used and reduces unnecessary exposure to chemicals, while achieving a long-lasting consistent treatment for as long as the micro-dosing treatment protocol lasts. In general, the controller may provide consistently equal dosages (delivered by a predetermined drug delivery volume) with control over the time interval between dosages, time duration of the dose or average dosing rate.

If the half-life time of the drug efficacy is significantly longer than the time intervals between discrete dosages, then one can maintain a steady dosage level on the animal skin/coat/fur with these discrete dosages. There may be minor fluctuations in the concentration level of active/s in between the discrete dosages, but these are relatively minor and do not impair the efficacy of the treatment.

By controlling the average dosing rate one can control the amount or concentration of the active drug on the animal skin/coat/fur. If the average dosing rate is increased by decreasing the time intervals between discrete dosages, the amount or concentration of the active drug on the animal skin/coat/fur is increased.

As noted above, a higher level or concentration of the substance is required on, or in the body, of the animal to treat pre-treatment infestations. This is referred to as the initial kill threshold level. An amount of substance above the initial kill threshold level for sufficient time will achieve the required initial kill efficacy.

Once the pre-treatment infestation is eliminated, a lower level or concentration of the substance is sufficient to maintain a clean animal and to treat, kill or repel any new infestation. This level is referred to as sustained or ongoing kill threshold level.

As noted above, the first efficacy level (Level 1) is the concentration of the active/s needed to treat the initial infestation. The second efficacy level (Level 2), usually lower than the first efficacy level, is the concentration of the active/s needed to control or prevent further infestation after eradication or reduction of the effects of the initial infestation.

Accordingly, the dosing protocol in one aspect of the invention achieves an initial kill efficacy to treat the initial infestation and a sustained kill or repel efficacy for an extended time period, all the while minimizing exposure to toxic substances and minimizing the total amount of the required substance or substances.

The delivery device of the invention includes a controller for controlling the drug delivery, which may be according to different protocols, in combination with animal well-being. The controller integrates drug delivery to the animal with sensed well-being of the animal.

In the prior art, drug delivery systems are separated from animal well-being systems. In the prior art, detection of well-being parameters typically involves observation by the animal owner or veterinarian over a period of time. Only after the observations are made, decisions are made regarding the drug delivery.

In the present invention, by contrast, drug delivery is controlled and monitored and the well-being of the animal is monitored as well, throughout the treatment period. The drug delivery and the well-being of the animal may be presented to the user and/or to a veterinarian in an integrated system. In some cases, the control of drug delivery is with respect to the well-being of the animal, or to specific indicators of animal's well-being. This provides synergy between the well-being and the drug delivery: the amount of drug delivered can be adjusted corresponding to specific conditions and may be significantly reduced since the drug is administered before a well-being problem becomes worse. Furthermore, since the animal is treated immediately with the drug, the animal's health and happiness are maintained, leading to better health and reduced health costs.

The controller (which may include multiple controllers working in cooperation) may communicate through any communication link, smartphone application (App), etc. The one or more devices for drug delivery and sensing well-being may be a single unit or multiple units, with some portions reusable and others disposable, for example. The one or more devices may be all on the animal, one or more on the animal and one or more not on the animal, or the one or more devices may be all not on the animal, with communication between the devices (wired or wireless), or alternatively even without a need for communication between them.

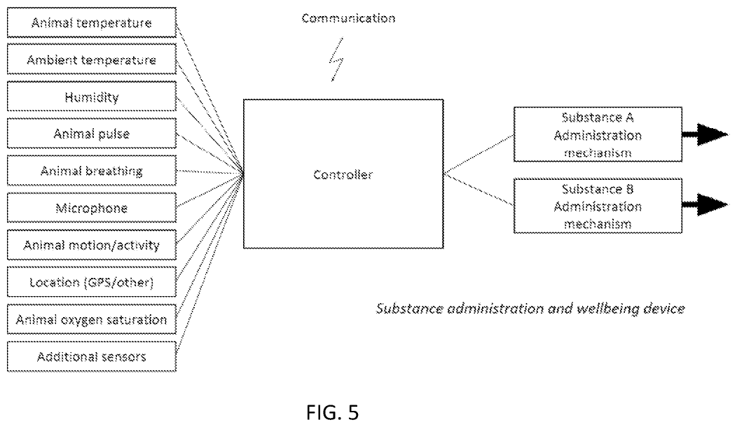

FIG. 5 shows a general block diagram of the system. A controller may be in communication (wired or wireless) with a database, user, veterinarian, hospital, animal owner, drug supplier and others. The controller may be in communication with any kind of well-being sensor, such as but not limited to, an animal temperature sensor, an ambient temperature sensor, humidity sensor, animal pulse sensor, animal breathing sensor, microphone, animal motion or activity sensor (e.g., accelerometer or other), location sensor (e.g., GPS or other), animal oxygen saturation sensor, or other additional sensors.

Well-being in the prior art is very often subjective: the pet owner or veterinarian looks at the animal and decides the state of well-being of the animal, without taking temperature, blood tests, etc., and without any feedback as to the outcome of taking some action (giving pain relief medication, etc.). In the present invention, well-being becomes more objective and measurable and takes out the guessing from the prior art subjective opinions. In the present invention, well-being is a comparison of a well-being parameter, or multiple parameters (such as, but not limited to, animal temperature, ambient temperature, humidity, animal pulse, animal breathing, animal sounds, animal motion or activity, geographical location, climatic conditions, animal oxygen saturation, and many others) with a known well-being parameter, or multiple parameters. For example, the known well-being parameter may be stored in a database and may include what is considered the normal temperature range for the animal or the normal range for any of the other parameters, such as normal range of head movement, leg movement and the like).

As another example, the known well-being parameter may be a parameter measured previously for that animal. In this manner, the well-being of the animal is a function of the current well-being parameter compared with a previous well-being parameter that was measured previously for that animal (such as but not limited to, seconds before, minutes before, hours before, days, weeks or months before, etc.). The well-being of the animal may be assessed and learned over time based on changes in well-being parameters measured over time. Changes over time, even if small, may provide important indications of the well-being of the specific animal. For example, a consistent decrease in the level of animal activity over time correlated to other indicators, such as asymmetric walking, may indicate a pain caused by a medical problem in the joints or a specific joint. Such well-being indications may assist a veterinarian in prescribing medication for the animal and in defining the recommended medication dose. In addition, or alternatively, such well-being indications may be used as a feedback for automatic closed-loop administration of the medication.

As another example, the known well-being parameter may be a parameter previously measured, or previously defined as a normal range, for an animal of similar age, weight, breed and other characteristics. In this manner, the well-being of the animal is a function of the current well-being parameter compared with the parameter previously measured, or previously defined as a normal range, for an animal of similar age, weight, breed and other characteristics.

The controller compares the sensed well-being parameter with the normal range of the parameter. The controller can then control drug delivery based on this comparison. Alternatively, the controller can control drug delivery and afterwards compare the sensed well-being parameter after activity of the drug with the normal range of the parameter, and then further control drug delivery based on this comparison. The comparison, analysis and decision making can also be done, or assisted, by a remote part of the system or user such as animal owner smartphone, veterinary computer, cloud server or any other system.

One non-limiting example of the integration of drug delivery with well-being includes controlling the drug delivery protocol and amount of anti-parasite and repelling substances (spot-on or other), which are administrated subject to the animal activity (indoor vs. outdoor; amount of animal scratching indicating presence of parasites, such as fleas, and being annoyed, and other pet wellbeing indicators).

The system may sense scratching or other behavior by sensing a series of movements or accelerations, which may be short, quick and of increased amplitude (e.g., at a frequency of several cycles per second), which are easily distinguished from other movements of the animal, such as running, walking, breathing, and others.

It is noted that monitoring/sensing scratching or other behavior gives an indication and feedback to the system of the invention, so that the system can modify the dosage in accordance with such feedback. In addition, these indications and feedback can be used to indicate and warn of termination of the treatment (or advanced warning that the treatment is about to end in a certain amount of time), or a malfunction in the system or any other warning to the user/veterinarian. It is noted that independently of these particular indications and feedback, the system can indicate and warn of end or termination of the treatment (or advanced warning that the treatment is about to end in a certain amount of time), or a malfunction in the system or any other warning to the user/veterinarian.

Another non-limiting example of the integration of drug delivery with well-being includes choosing the treatment protocol and/or amount of anti-parasite and repelling substances subject to environmental conditions (such as but not limited to, ambient temperature; humidity; time and season; geographic area/location, time of day), and providing information about the drug delivery and/or well-being.

In addition to sensors in the device providing indications about the specific animal, relevant information may be provided from a database (that may be provided by a cloud server) via the communication link to further support/improve the treatment/substance-administration. For example, the system can provide relevant geographic related information, such as but not limited to, expected level of parasite presence and activity in the specific area and the specific season; level of parasite immunity to the used formulation in the specific area (so higher doses of formulation may be necessary) and others.

Another non-limiting example of the integration of drug delivery with well-being includes controlling protocol and amount of pain relief medication subject to animal behavior (level and profile of activity and animal motion indicating the level of pain, or detection of limp or abnormal behavior as indicator of pain, or any other biological indicators of animal's stress or pain).

Another non-limiting example of the integration of drug delivery with well-being includes administration of calming agents (such as specific pheromones) to calm down the animal subject to its detected level of stress/anxiety/restless behavior/any other indications.

Another non-limiting example of the integration of drug delivery with well-being includes sending drug/substance delivery and well-being information to a database (e.g., cloud-based database) and providing a service wherein healthcare personnel consult the database and provide diagnostics, subscriptions, medical test results and more, to the user or pet owner. In this manner, the system of the invention provides monitoring, tracking, learning, diagnosing, and reporting services of the animal well-being, while providing clear comparisons of any well-being parameter or index over time, and alerting or identifying any changes with respect to previous well-being parameters, as described above.

Delivery or administration of medications, drugs or substances, and collecting, tracking or analyzing well-being parameters or information, are part of animal health care. Integrating these functions into one system brings together treatment and assessment of animal well-being so as to provide better overall animal health care.

The availability and immediate access to animal's well-being data compared to a normal range (e.g., derived from other animals, and which may be available via a cloud server database) serve and support the animal owner and the veterinary services to provide the best possible care and treatment.

Integrating drug delivery and well-being in one system together with immediate access or availability to a broad database of animal health knowledge and understanding provides the invention with unique synergy because the combined effect of drug delivery with well-being (including comparison of well-being indicators over time and a broad database of animal health knowledge) significantly improves both drug delivery and well-being. Since animals cannot readily communicate all kinds of well-being indications to their owner/veterinarian, the sensed well-being indicators may be crucial in assessing and monitoring the well-being of the animal.

Applicator Description

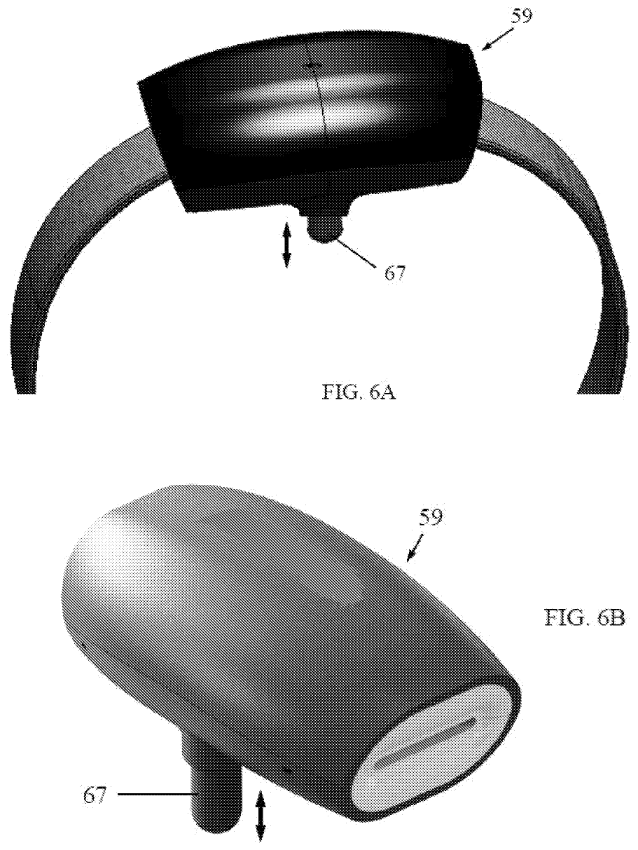

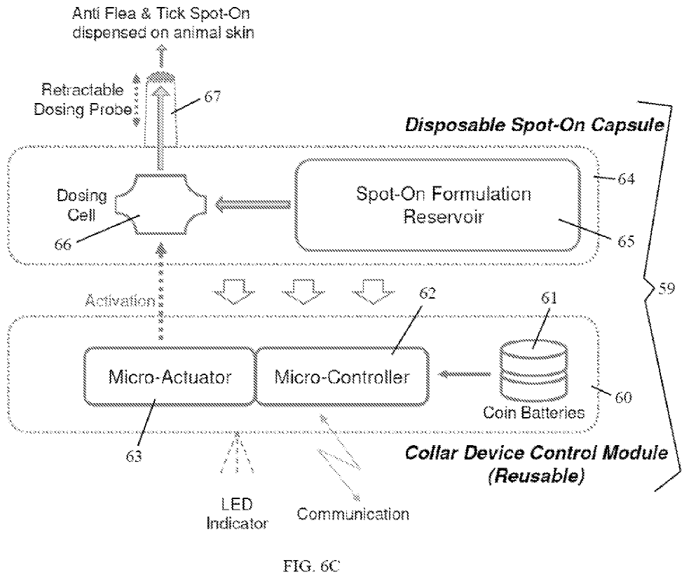

Reference is now made to FIGS. 6A, 6B and 6C, which illustrate a device (also called applicator) for delivery of substances to animals, constructed and operative in accordance with a non-limiting embodiment of the present invention.

Without limitation, as seen in FIG. 6C, the applicator 59 includes a controller 60 containing a battery or batteries 61, a micro-controller 62 and an micro-actuator 63, and a cartridge 64 (capsule, container, and the like) containing spot-on formulation reservoir 65 and a micro-dosing cell 66 designed to dose a fixed micro-dose volume of formulation (e.g., measured in micro-liters), at a time. The micro-dosing cell 66 has inlet and outlet ports. The inlet port is connected to the sealed formulation reservoir 65 and the outlet port is connected to a retractable dosing probe 67. According to a predefined dosing protocol, a single measured micro-dose of formulation is dosed at a time from the probe onto the skin of the animal.

FIG. 6A shows the applicator attached onto a pet collar. The collar with the attached applicator may be put around the neck of the animal with the dosing probe gently pressed towards the skin of the animal.

The probe may retract into the device in a variety of manners. For example, the probe may be spring-loaded. As another example, the probe may be telescoping or shaped like a bellows such that it nests into itself as it retracts. As another example, the probe may be resilient and flexible (e.g., made of an elastomeric material or of a flexible plastic lining hinge) so that it deforms as it gets pushed into the device. It is noted that a non-retractable probe may be problematic for use with a wide variety of furs. For example, a short, fixed length probe may be used for short-haired animals, but may be ineffective for long-haired animals; conversely, a long, fixed length probe may be used for long-haired animals, but may be ineffective for short-haired animals because the probe would distance the device from the animal skin. The retractability of the probe enables using the device for any kind of fur.

Most of the active ingredients (actives) used in spot-on formulations dissipate following a similar pattern over time (in good proximity, first-order exponential decay), therefore, the active ingredient amounts at any time are expected to follow the following equation,

A(t)=A(0)*e^{-kt}

Where A is the active amount, either at any time A(t) or in t=0, A(0). k is the decay rate constant of the specific active. Hence, the level of an active ingredient at any time depends directly on its dissipation properties as well as on the dose administered, A(t=0)=A(0).

In case of a manual one monthly spot-on treatment, in order to maintain a certain minimal level (e.g. effective level) of actives, after 30 days for example, one has to apply a relatively high dose on day 0 (as seen in FIGS. 3C and 3D). This amount increases dramatically with the increasing of the claimed treatment time.

As a result, the pet, humans around it and the environment are repeatedly exposed to “overdose” peaks of high levels of active ingredient(s) at each monthly treatment.

In one aspect of the invention, the treatment protocol is based on applying micro-doses of formulation at consecutive intervals throughout a prolonged treatment period (e.g., without limitation, 3 months treatment). The protocol maintains a desired level of actives on the skin throughout the entire treatment duration, while minimizing the total amount of formulation used, and completely avoiding “overdose” peaks of high level of actives. The protocol balances the safety and efficacy requirements, thus allowing for prolonged periods of treatment with topical formulations. The applicator is designed to automatically micro-dose formulations according to the treatment protocol, thus eliminating the need for manual administration of the formulation.

In one non-limiting application of the invention, the applicator is designed and programmed to fit four (4) dog weight categories, in a similar way to spot-on products on the market. Each weight category is assigned a suitable dosing protocol to maintain a defined Average Daily Dose (ADD) as appropriate for the specific weight category. It should be noted that the smaller dogs in each weight category will be treated with a higher Average Daily Dose per kg of dog weight, compared to the larger dogs in the weight category. Alternatively, applicators may be set/programmed to dose an Average Daily Dose calculated and customized for the specific weight of each individual dog. Setting the specific animal weight can be done via a smartphone App, or other communication means, by the user or by an authorized party, such as a veterinarian. In this manner all dogs, or other animals, will be treated with the exact desired/optimized dose.

The Average Daily Dose (ADD) calculated for a specific dog:

$$A D D [ \frac{ml}{day} ] = Average Daily Dose per Kg [ \frac{\frac{ml}{Day}}{Kg} ] * Dog weight [ Kg ]$$

The Average Daily Dose (ADD) may be derived by:

$$A D D [ \frac{ml}{day} ] = \frac{Applicator discrete dose [ ml ]}{Δ T [ day ]}$$

where (ΔT) is the time gap between two consecutive discrete doses.

Hence, to adjust each applicator to the required Average Daily Dose of each specific dog, the time gap between two consecutive discrete doses (ΔT) is calculated and determined by:

$$Δ T [ day ] = \frac{Applicator discrete dose [ ml ]}{( Average Daily Dose per Kg ) [ \frac{ml}{day} / kg ] \times ( Dog weight ) [ kg ]}$$

1. A method of delivering a substance to an animal comprising:
using a controller to topically deliver an initial dosage amount of a substance to a skin of an animal, followed by one or more subsequent dosages of said substance to the skin of said animal, wherein said initial dosage amount comprises a plurality of sub-initial doses delivered at discrete time intervals separated from one another by time gaps and a total amount of said sub-initial doses equals said initial dosage amount.

2. The method according to claim 1, wherein said substance is a pest control substance and said initial dosage amount results in a concentration of one or more actives on said skin exceeding a first active concentration threshold level necessary for achieving a first efficacy level for performing an initial kill of pests that have infested said animal before administration of said initial dosage amount, wherein said initial kill is achieved within 4, 12, 24, 48, 72, or 96 hours.

3. A method of delivering a substance to an animal comprising:
using a controller to topically deliver an initial dosage amount of a substance to a skin of an animal, wherein said initial dosage amount results in a concentration of one or more actives on said skin exceeding a first active concentration threshold level necessary for achieving a first efficacy level for killing pests that have infested said animal before administration of said initial dosage amount, followed by one or more subsequent dosages of said substance to the skin of said animal, wherein said one or more subsequent dosages result in a concentration of said one or more actives on said skin exceeding a second active concentration threshold level necessary for achieving a second efficacy level for killing or preventing or deterring re-infestation of said animal.

4. The method according to claim 3, wherein said second efficacy level is less than said first efficacy level.

5. A method of delivering a substance to an animal comprising:
using a controller to topically deliver dosages of a substance to a skin of an animal at discrete time intervals separated from one another by time gaps, and wherein each of said time gaps is smaller than a half lifetime of one or more actives on said skin, so that a concentration of said one or more actives on said skin is maintained above an efficacy threshold during an entire time of treatment.

6. (canceled)

7. The method according to claim 1, wherein said one or more subsequent dosages are smaller than said initial dosage amount.

8. The method according to claim 1, wherein said initial dosage amount is zero.

9. The method according to claim 1, comprising using said controller to modify dosages of said substance.

10. The method according to claim 9, wherein dosages of said substance are modified by taking into account an environmental factor, a climate change, a temperature change a humidity change, an immunity level of said animal, or presence of an allergen, an irritant or a pest.

11. The method according to claim 1, comprising using said controller to modify a time interval between dosages of said substance, a time duration of dosage of said substance, or an amount of dosage of said substance.

12. The method according to claim 1, comprising using said controller to select between different dosing protocols, wherein said initial dosage amounts of said dosing protocols are selected from zero to an amount larger than zero, and said one or more subsequent dosages are selected from zero to an amount larger than zero.

13. The method according to claim 12, wherein selection of one of said dosing protocols is done taking into account at least one of the following parameters: a data base, a specific animal breed, animal weight, hair length, time spent by the animal indoors or outdoors, usage history, seasonality, time of year, geography, immunity level of the animal, adverse or allergic reactions to said substance, climate, temperature, humidity, anxiety factors, and behavioral data.

14. The method according to claim 1, comprising using said controller to synergistically combine topical dosage of said substance in cooperation with a well-being device.

15. The method according to claim 1, wherein said substance comprises a combination of different substances.

16-20. (canceled)
